(19) United States
(12) Patent Application Publication
(10) Pub. No.: US 2014/0247368 A1
(43) Pub. Date: Sep. 4, 2014

(54) READY CLICK CAMERA CONTROL

(71) Applicant: COLBY LABS, LLC, Bellevue, WA (US)

(72) Inventor: VICTOR K. CHINN, BELLEVUE, WA (US)

(73) Assignee: COLBY LABS, LLC, BELLEVUE, WA (US)

(21) Appl. No.: 13/784,234

(22) Filed: Mar. 4, 2013

(51) Int. Cl. H04N 5/232

(52) U.S. Cl. CPC H04N 5/23222
USPC 348/207.1

(57) ABSTRACT

Technologies relating to “ready click” camera control are disclosed. Camera devices may be equipped with a camera, a microphone, a processor, a memory, and a camera control system stored in the memory and executable by the processor. The camera control system may be configured to provide any of a variety of voice-interactive features, such as a voice-activated shutter, a voice-activated timer, a voice-activated flash, a voice-activated focus setting, a voice-activated ISO setting, a voice-activated scene setting, and/or a variety of other features, including both voice-interactive as well as other features described herein.

### BACKGROUND

As the capabilities of electronic devices expand, as mobile devices increasingly include camera functions as well as a variety of other useful functions, and as dedicated camera devices increasingly include computing capabilities and other useful functions, there is a need for camera control systems that provide more powerful features, better user interactions and more user interaction options.

### SUMMARY

Technologies relating to “ready click” camera control are disclosed. Some example camera devices equipped according to this disclosure may comprise a camera, a microphone, a processor, a memory, and a camera control system stored in the memory and executable by the processor. The camera control system may be configured to provide any of a variety of voice-interactive features, such as a voice-activated shutter, a voice-activated timer, a voice-activated flash, a voice-activated focus setting, a voice-activated ISO setting, a voice-activated scene setting, and/or a variety of other features, including both voice-interactive as well as other, non voice-interactive features described herein.

Some example camera control system User Interfaces (UI) may comprise elements associated with the voice-interactive features described herein, and/or a variety of other elements described herein. For example, camera control system UI may comprise multiple camera activation controls, the multiple camera activation controls comprising a listening initiation control, a timer initiation control, and/or a camera activation control. In some embodiments, camera control system UI may comprise features such as user-customizable audible notifications, user activated rule of thirds grids with user-guided autofocus, user activated composition guides, user activated camera instructions, and/or any of a variety of other features described herein.

Methods and computer readable media having instructions implementing the various technologies described herein are also disclosed. Example computer readable media may comprise non-transitory computer readable storage media having computer executable instructions executable by a processor, the instructions that, when executed by the processor, implement the camera control system provided herein. Example methods may include interactions between cameras equipped with camera control systems provided herein and camera users, in which the cameras provide UI, receive user voice and/or other inputs such as touch inputs, and respond to the user inputs according the various techniques described herein.

### BRIEF DESCRIPTION OF THE DRAWINGS

The accompanying drawings depict several embodiments in accordance with this disclosure. The drawings are not to be considered as limiting. Other embodiments may be utilized, and changes may be made, without departing from the spirit or scope of the subject matter presented here. It will be understood that aspects of the present disclosure may be arranged, substituted, combined, and designed in a wide variety of different configurations.

FIG. 1 illustrates an example camera device.

FIG. 2 illustrates an example camera UI

FIG. 3 illustrates a first example settings menu UI.

FIG. 4 illustrates a second example settings menu UI.

FIG. 5 illustrates a third example settings menu UI.

FIG. 6 illustrates a fourth example settings menu UI.

FIGS. 7A, 7B, and 7C illustrate an example camera UI including various camera UI overlays.

FIG. 8 illustrates a fifth example settings menu UI.

### DETAILED DESCRIPTION

Various example embodiments are described in detail herein. The detailed embodiments are not to be considered as limiting. Other embodiments may be utilized, and changes may be made, without departing from the spirit or scope of the subject matter presented here. It will be understood that aspects of the present disclosure may be arranged, substituted, combined, and designed in a wide variety of different configurations.

As stated in the summary section, technologies relating to “ready click” camera control are disclosed. Some example camera devices equipped according to this disclosure may comprise a camera, a microphone, a processor, a memory, and a camera control system stored in the memory and executable by the processor. The camera control system may be configured to provide any of a variety of voice-interactive features, such as a voice-activated shutter, a voice-activated timer, a voice-activated flash, a voice-activated focus setting, a voice-activated ISO setting, a voice-activated scene setting, and/or a variety of other features, including both voice-interactive as well as other, non voice-interactive features described herein.

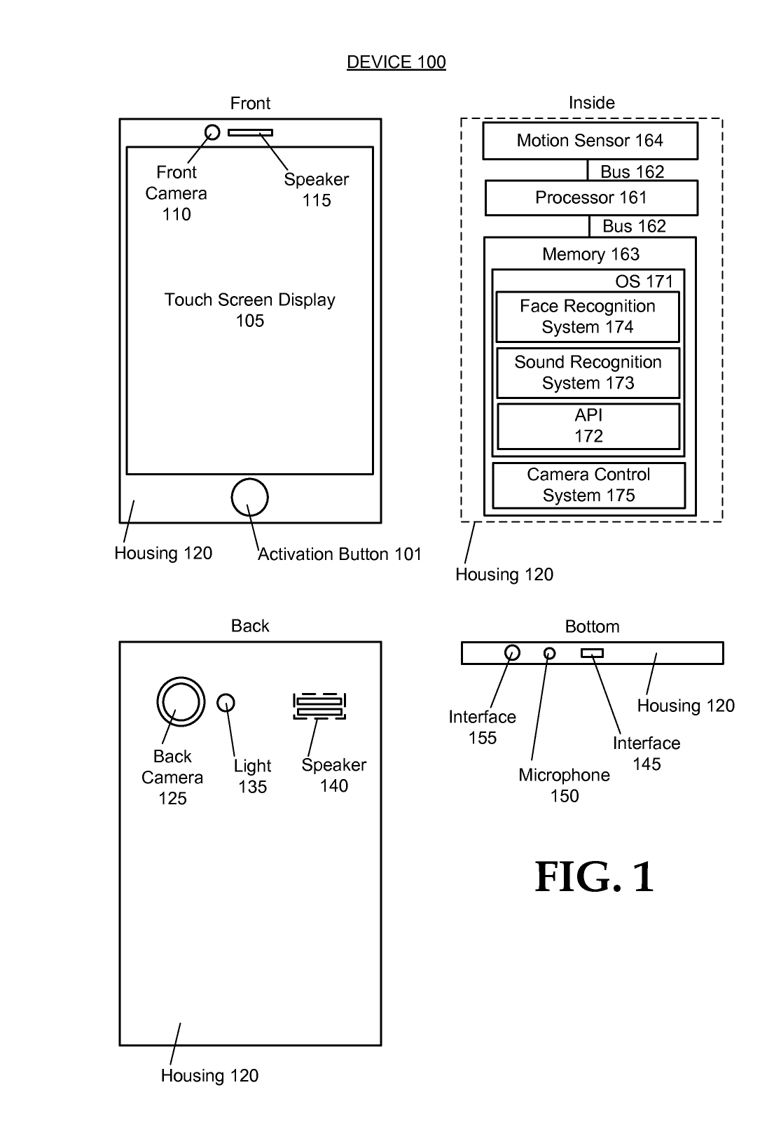

FIG. 1 illustrates an example camera device in accordance with some embodiments of this disclosure. FIG. 1 includes a front view, inside view, and bottom view of a device 100. The device 100 may take the form of a mobile device such as a smart phone. Device 100 comprises a device activation button 101, touch screen display 105, front camera 110, speaker 115, housing 120, back camera 125, light 135, speaker 140, interface 145, microphone 150, interface 155, processor 161, bus 162, memory 163, and motion sensor 164. Memory 163 includes an Operating System (OS) 171 and camera control system 175. OS 171 includes API 172, a sound recognition system 173, and a sound recognition system 174. In some embodiments, the camera control system 175 may be configured as a mobile application or “app” installed on device 100, along with any number of other mobile applications which may be installed on device 100.

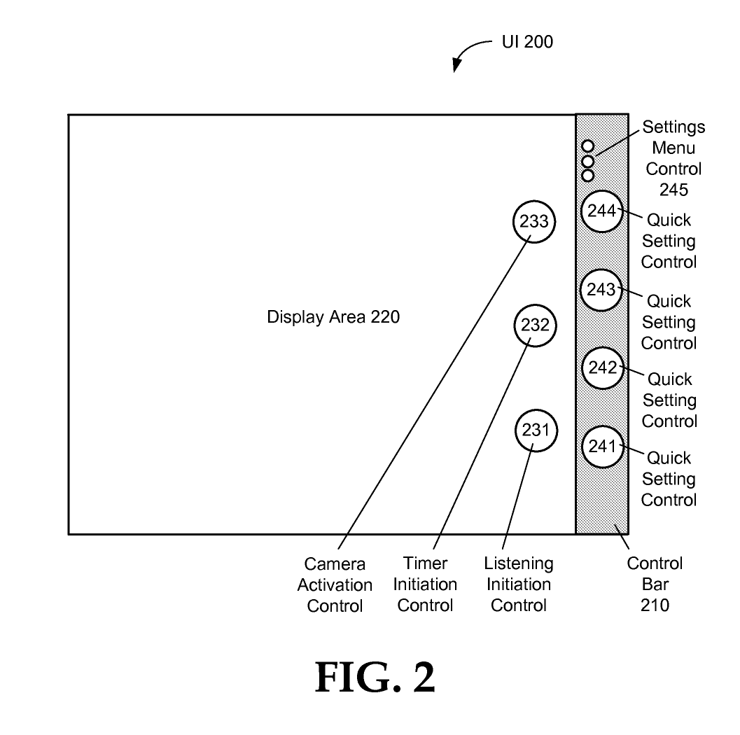

In some embodiments, the camera control system 175 may be configured to produce UI on the display 105 in accordance with FIG. 2-FIG. 8, and to carry out corresponding methods. The camera control system 175 may also be configured to interact with OS 171 via API 172, which may include several different APIs, to cause the device 100 to execute instructions received via the camera control system UI. It should be appreciated that FIG. 1 illustrates a camera device 100 as well as a computer readable medium 163 having computer executable instructions configured according to the camera control system 175 described herein. When the device 100 carries out the instructions included in the computer readable medium 163, the device 100 thereby carries out various methods according to this disclosure.

It will be appreciated that the device 100 may take the form of any computing device and is not limited to the form of a mobile device. For example, in some embodiments, device 100 may take the form of a dedicated camera type device rather than a mobile phone type device as illustrated in FIG. 1. Also, it will be appreciated that device 100 may include any number of additional features and configurations.

The camera control system 175 may be described herein as comprising features presented in camera control system UI, such as those features illustrated FIG. 2-FIG. 8. For example, camera control system 175 may be described as comprising a listening initiation control as illustrated in FIG. 2. It will be appreciated that camera control system 175 comprises features presented in camera control system UI by having functional modules configured to present such features in camera control system UI. The functional modules may be made using any of a variety of techniques known in the electronic arts, e.g., by writing source code and compiling the source code into machine-executable modules.

Also, camera control system 175 may be described herein as comprising features that are implemented within OS 171 and/or device 100, which features may be accessed or otherwise utilized by camera control system 175. It will be understood that functional modules in devices such as device 100 may generally be implemented as an integrated part of, or otherwise tightly integrated with specific systems such as camera control system 175, or may be implemented external to or loosely integrated with systems such as camera control system 175. When camera control system 175 is adapted to access and make use of functional modules “external” to, or not tightly integrated with camera control system 175, camera control system 175 may nonetheless be described herein as comprising such features. For example, camera control system 175 may be configured to access sound recognition system 173 and face recognition system 174, as well as optionally a main camera control system (not shown in FIG. 1) in OS 171, and therefore camera control system 175 may be described herein as comprising a sound recognition system, a face recognition system, and/or aspects of a main camera control system provided by OS 171. Placement of functional modules such as sound recognition system 173, face recognition system 174, and/or a main camera control system in OS 171 rather than exclusively within camera control system 175 is a design choice which may allow use of these functional modules or other features by camera control system 175 as well as other applications installed on device 100.

In some embodiments, API 172 may comprise a camera API adapted for application-based pre-image capture camera control. Camera control system 175 may comprise an application executable by device 100 and configured to access the camera API. For example, camera control system 175 may comprise a “lens” app compatible with an OS such as the WINDOWS® Phone 8 OS. Lens apps may integrate with camera control software which may be included in the OS, e.g., lens apps may integrate with a built-in main camera app. The lens app may provide unique camera functions which are combined with functions of the OS-based main camera app. The lens app may also access, for example, a sound recognition API, a face recognition API, a motion sensor API, and/or any other APIs as needed to implement the various features described herein.

FIG. 2 illustrates an example camera UI 200. Camera control system 175 may be configured to present UI 200 on a display such as touch screen display 105. Camera control system 175 may be configured receive commands from a user via UI 200, and to execute received commands with the device 100. Example UI 200 comprises a display area 220, multiple camera activation controls 231, 232, and 233, and a control bar 210 comprising settings controls 241, 242, 243, 244, and 245. The display area 220 may be configured to display an image from a camera, e.g., camera 125. The multiple camera activation controls may include a listening initiation control 231, a timer initiation control 232, and a camera activation control 233. The settings controls may comprise one or more quick settings controls 241, 242, 243, and 244, and a settings menu control 245.

In some embodiments, camera control system 175 may comprise a listening initiation control 231 as illustrated in FIG. 1, and a sound recognition system 173 as illustrated in FIG. 2. The camera control system 175 may be configured to initiate listening by device 100 to sound data received via the microphone 150 in response to user activation of the listening initiation control 231, and the sound recognition system 173 may be configured to recognize a predetermined camera activation sound pattern in the received sound data. The camera control system 175 may be configured to activate the camera, which may be either or both of camera 110 and/or camera 125, to take a photograph or begin recording a video in response to the predetermined camera activation sound pattern. For example, in some embodiments, the predetermined camera activation sound pattern may comprise three or more syllables, such as the words “ready click”. The camera control system 175 may be configured to activate the camera 125 to take a photograph or begin recording a video in response to the words “ready click”. Camera 125 will generally be referred to as an example camera in this disclosure, understanding that either camera 110 or 125 may be included in operations discussed herein.

Any desired matching criteria may be used to define when received sound data can be matched to the predetermined camera activation sound pattern. For example, in some embodiments, unclear speech, speech with different volume levels and accents, and speech in the presence of background noise may nonetheless be interpreted as “close enough” to the predetermined camera activation sound pattern to activate camera 125. Criteria defining when received sound data matches the predetermined camera activation sound pattern may be set as appropriate for specific embodiments. In some embodiments, sound recognition system 173 may comprise a voice recognition engine designed to recognize human speech, optionally in a language according to a language setting for device 100. API 172 may provide an API by which camera control system 175 may request notification of received voice commands.

In some embodiments, camera control system 175 may be configured to receive, recognize, and respond to additional voice commands. For example, after user activation of the listening initiation control 231, camera control system 175 may respond to the predetermined camera activation sound pattern by activating the camera 125 as described above, and camera control system 175 may respond to any of a variety of other voice commands, such as a “set timer” command, a “set flash” command, a “set focus” command, a “set ISO” or “set speed” command, and/or a “set scene” command.

In some embodiments, camera devices such as device 100 may comprise speakers such as speaker 115 and speaker 140, and camera control systems such as 175 may be configured to output audible requests and notifications by one or more of the speakers. For example, camera control system 175 may output an audible notification by speaker 140, such as, “now listening”, when initiating listening in response to the user activation of the listening initiation control 231.

In some embodiments, camera control system 175 may output audible notifications by speaker 140 when responding to commands by affirming that a command is executed. For example, in response to a “set timer: 10 seconds” command, camera control system 175 may output an audible notification by speaker 140 such as “timer set”, and camera control system 175 may then proceed to output an audible countdown to camera activation. In response to a “set flash: on” command, a “set flash: off” command, or a “set flash: auto” command, camera control system 175 may output an audible notification by speaker 140 such as “flash on”, “flash off”, or “automatic flash”. Camera control system 175 may then optionally continue listening and may output a subsequent audible notification by speaker 140 such as, “now listening”. Camera control system 175 may output similarly appropriate audible notifications by speaker 140 in response to “set focus”, “set ISO/speed”, and/or a “set scene” commands, and may optionally return to listening thereafter.

In some embodiments, camera control system 175 may be configured to display multiple camera activation controls, the multiple camera activation controls comprising, for example, the listening initiation control 231, timer initiation control 232, and camera activation control 233. Camera control system 175 may present the multiple controls simultaneously as illustrated in FIG. 2, or one at a time or in different groups or arrangements in some embodiments. For example, in some embodiments, a settings menu may allow the user to select which camera activation controls he/she wishes to see in camera UI 200.

Camera control system 175 may be configured to output an audible countdown by a speaker 140 in response to a user initiation of the timer initiation control 232, and to automatically activate the camera 125 after the audible countdown. For example, camera control system 175 may output an audible countdown from 10 to 1, and may then automatically activate the camera 125. In some embodiments, camera control system 175 may optionally also output an audible notification, such as “say cheese” or “activating camera” prior to activating camera 125.

Camera activation control 233 may also be referred to herein as a shutter control. In some embodiments, camera control system 175 may be configured to immediately activate the camera 125 in response to user selection of the camera activation control 233. In some embodiments, camera control system 175 may be configured to provide controls for user selection of settings adapting response of the camera control system 175 to selection of the camera activation control 233. Camera activation control 233 may therefore comprise a user-configurable camera activation control, which allows a camera 125 to be activated in a manner specified by the user of the camera device 100, as described in further detail herein.

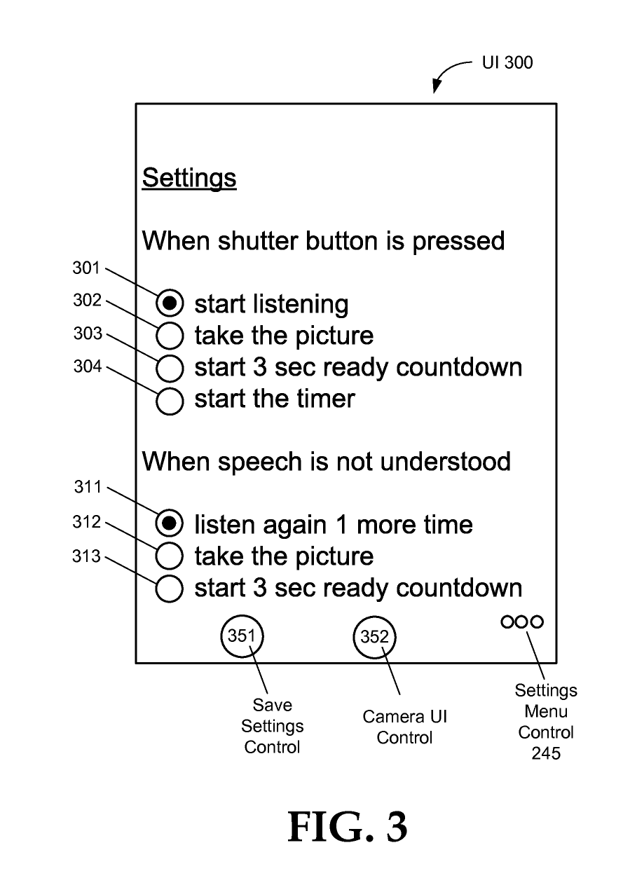

Camera control system 175 may be configured to provide one or more settings menus for user control of camera device 100 and/or camera control system 175 settings in response to user selection of settings menu control 245. Example settings menus are provided in FIG. 3-FIG. 6 and FIG. 8. UI 200 may also comprise any number of quick settings controls such as 241, 242, 243, and/or 244 for adjusting settings without navigating to settings menus. Quick settings controls may include, for example, a flash control 241, a camera selection control 242, a multiple photographs control 243, and an overlay control 244.

Flash control 241 may be adapted to change a flash setting applied by camera control system 175. For example, a flash setting may be changed between flash on, auto, and off settings. Camera control system 175 may apply a next flash setting in response to each successive user selection of flash control 241. Camera selection control 242 may be adapted to change a camera selection setting applied by camera control system 175. For example, a camera selection setting may be changed between front camera 110 and back camera 125 settings. Camera control system 175 may apply a next camera selection setting in response to each successive user selection of camera selection control 242.

Multiple photographs control 243 may also be referred to herein as multi-photo control 243. Multi-photo control 243 may be configured to change a photograph number setting applied by camera control system 175. For example, a photograph number setting may be changed between one and two photographs. Camera control system 175 may be configured to automatically take the number of photographs specified via the multi-photo control 243 in response to user activation of any of controls 231, 232, and/or 233. Camera control system 175 may apply a next photograph number setting in response to each successive user selection of multi-photo control 243. For example, camera control system 175 may toggle between 1 and 2 photographs in response to successive user selection of multi-photo control 243, or camera control system 175 may go from 1 to 2, 3, 4 . . . up to any number of photographs, and then return to 1.

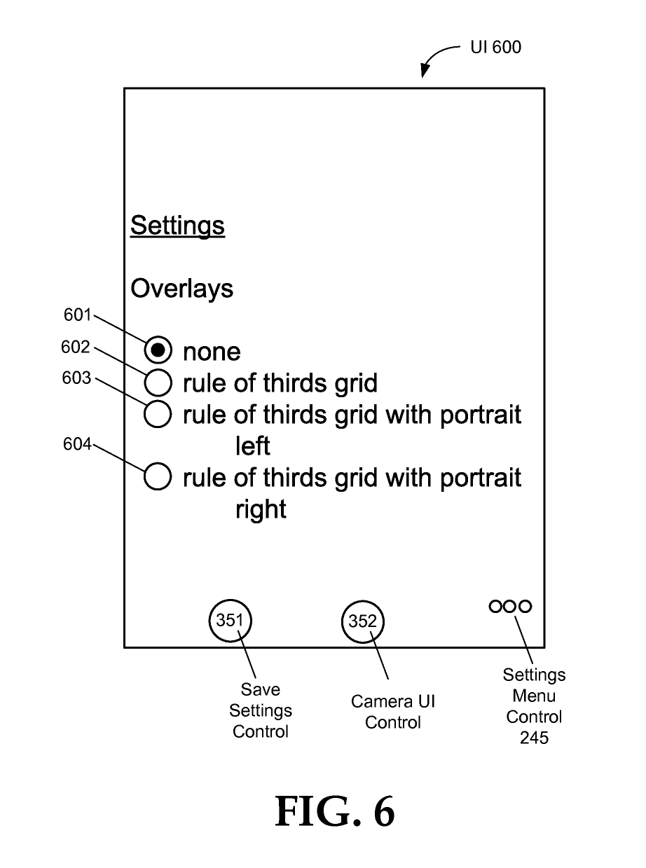

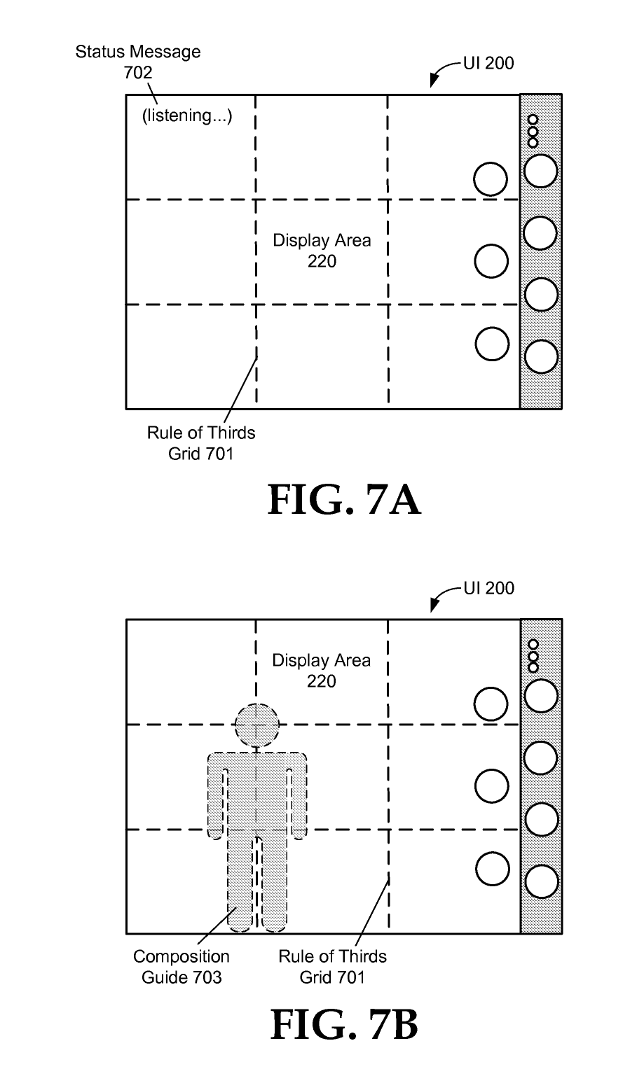

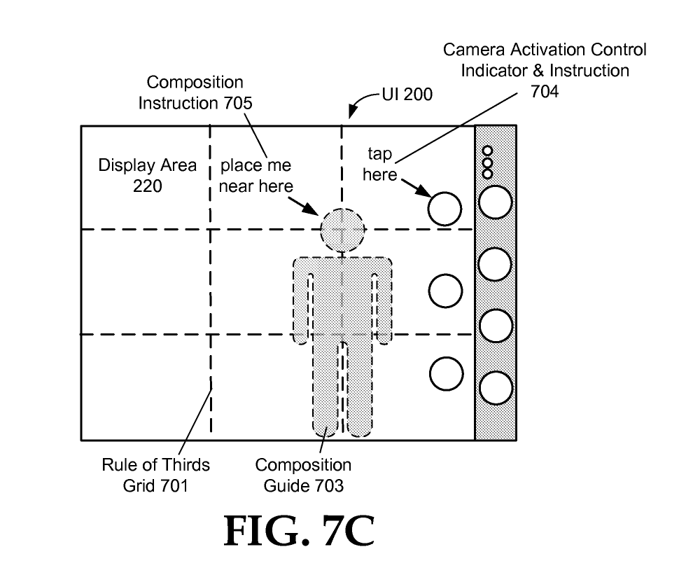

Overlay control 244 may be adapted to change an overlay setting applied by camera control system 175. For example, an overlay setting may be changed between no overlay, a rule of thirds grid overlay, a rule of thirds grid with portrait left overlay, and a rule of thirds grid with portrait right overlay. Camera control system 175 may apply a next overlay setting in response to each successive user selection of overlay control 244. Aspects of the rule of thirds grid overlay, rule of thirds grid with portrait left overlay, and rule of thirds grid with portrait right overlay are discussed further herein with reference to FIG. 6 and FIGS. 7A, 7B, and 7C.

FIG. 3 illustrates a first example settings menu UI 300. Camera control system 175 may be configured to present UI 300 on a display such as touch screen display 105. In some embodiments, camera control system 175 may provide a “master” settings menu, e.g., in response to user selection of settings menu control 245, the master settings menu comprising any number of selectable sub-menus. UI 300 may for example comprise a sub-menu accessible by selection of a sub-menu selection control from such a master settings menu. Camera control system 175 may be configured to return to the master settings menu in response to user selection of settings menu control 245 from UI 300. Camera control system 175 may be configured to save settings specified in UI 300, and to configure itself according to the received settings selections, in response to user selection of save settings control 351. Camera control system 175 may be configured to display camera UI 200 in response to user selection of camera UI control 352.

UI 300 comprises a settings menu including two menu categories. A first menu category provides controls for selecting actions by camera control system 175 when a shutter control 233 is pressed. The example controls include a selectable “start listening” control 301, a selectable “take the picture” control 302, a selectable “start 3 sec ready countdown” control 303, and a selectable “start the timer” control 304. In some embodiments, the controls 301-304 may be mutually exclusive, so that only one of controls 301-304 may be selected at a time. Selecting a control may automatically operate to de-select any previously selected control.

When the “start listening” control 301 is selected, the camera control system 175 may configure its shutter control 233 similarly or identically to listening initiation control 231. In other words, camera control system 175 may adapt its response to user selection of shutter control 233, so that camera control system 175 begins “listening” for a sound pattern in response user selections of shutter control 233, and camera control system 175 activates camera 125 to take a picture/initiate a video in response to the sound pattern.

When the “take the picture” control 302 is selected, the camera control system 175 may modify its response to user selection of shutter control 233, so that camera control system 175 immediately takes a picture/initiates video recording in response to user selection of shutter control 233. In some embodiments, immediately activating the camera 125 to take a picture/initiate video recording may be subject to stabilization delay as discussed in connection with control 507 and/or an audible notification as discussed in connection with control 501. Activating camera 125 after stabilization and/or an audible notification, without any countdown or waiting for a voice or other sound command, is understood herein to qualify as immediately activating the camera 125

When the “start 3 sec ready countdown” control 303 is selected, the camera control system 175 may modify its response to user selection of shutter control 233, so that camera control system 175 starts a countdown (such as a three second countdown or any other countdown duration) and then takes a picture/initiates video recording in response to user selection of shutter control 233. The countdown may be audible and the camera activation may be preceded by a preamble phrase as described herein. In some embodiments, the countdown activated by control 303 may comprise a fixed, minimal countdown of, e.g., 5 seconds or less, which is not user-configurable, unlike countdowns associated with control 232.

When the “start the timer” control 304 is selected, the camera control system 175 may configure its shutter control 233 similarly or identically to timer initiation control 232. In other words, camera control system 175 may adapt its response to user selection of shutter control 233, so that, in response to user selection of shutter control 233, camera control system 175 starts a timer and then takes a picture/initiates video recording after the time period specified for the timer elapses. For example, the time period may be 10, 15, or 20 seconds, or any other time period. The timer may also provide for an audible countdown and/or a preamble phrase as described herein. The time period initiated in connection with the timer may also be user configurable as described herein, e.g., in connection with controls 411-414.

A second menu category in FIG. 3 provides controls for selecting actions by camera control system 175 in response to receiving, after user selection of the listening initiation control 231, a sound pattern other than the predetermined camera activation sound pattern. The example controls include a selectable “listen again one more time” control 311, a selectable “take the picture” control 312, and a selectable “start 3 sec ready countdown” control 313. In some embodiments, the controls 311-313 may be mutually exclusive, so that only one of controls 311-313 may be selected at a time. Selecting a control may automatically operate to de-select any previously selected control.

When the “listen again one more time” control 311 is selected, the camera control system 175 may modify its response to receiving, after user selection of the listening initiation control 231, a sound pattern other than the predetermined camera activation sound pattern, so that camera control system 175 outputs an audible request by the speaker 140 for a subsequent audible input in response to receiving a sound pattern other than the predetermined camera activation sound pattern. For example, camera control system 175 may output an audible request such as, “I didn't understand that”. Meanwhile, camera control system 175 may continue to analyze incoming sound data for the predetermined camera activation sound pattern. Camera control system 175 may proceed to activate the camera when the predetermined camera activation sound pattern is recognized. In some embodiments, camera control system 175 may also proceed to activate the camera in response to any subsequent sound pattern (subsequent to receiving a first sound pattern other than the predetermined camera activation sound pattern), regardless of whether such subsequent sound pattern comprises the predetermined camera activation sound pattern.

When the “take the picture” control 312 is selected, the camera control system 175 may modify its response to receiving, after user selection of the listening initiation control 231 a sound pattern other than the predetermined camera activation sound pattern, so that camera control system 175 proceeds to activate the camera 125 in response to the received sound pattern other than the predetermined camera activation sound pattern. In other words, when control 312 is selected, the camera control system 175 may dispense with attempting to recognize detailed features of incoming sound patterns, and may instead activate the camera 125 in response any received sound pattern, whether or not the camera activation sound pattern is recognized. Of course, in some embodiments, parameters for amplitude and/or other parameters may be set to appropriately filter out background noise, non-voice sound inputs, or any other sound inputs which may be usefully excluded.

When the “start 3 sec ready countdown” control 313 is selected, the camera control system 175 may modify its response to receiving, after user selection of the listening initiation control 231 a sound pattern other than the predetermined camera activation sound pattern, so that camera control system 175 allows any sound pattern to activate the camera 125 as discussed above in connection with control 312, and camera control system 175 also starts a countdown and then activates the camera 125 as discussed above in connection with control 304. It will be appreciated that controls may be provided which combine settings applied by any of the controls discussed herein.

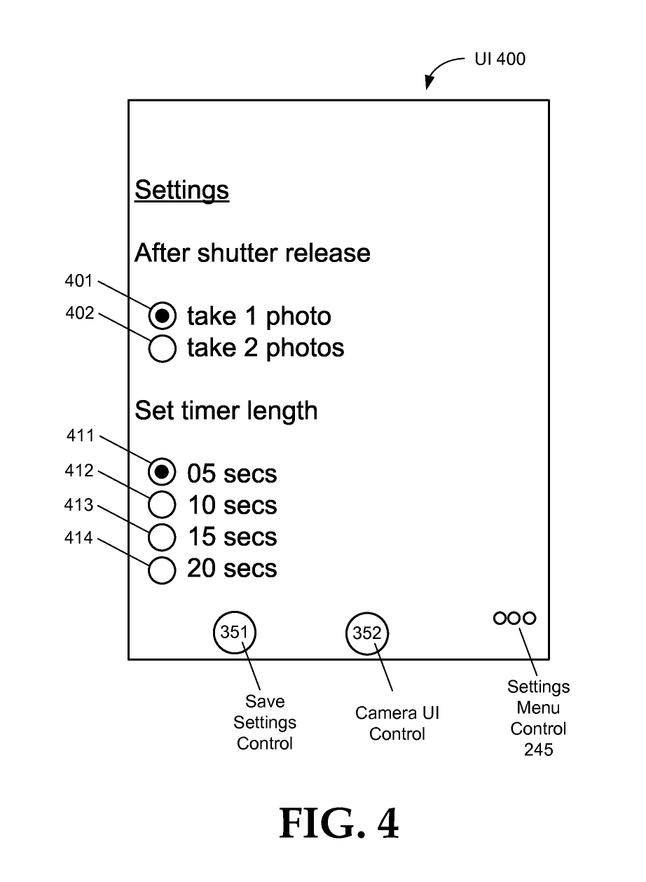

FIG. 4 illustrates a second example settings menu UI 400. Camera control system 175 may be configured to present UI 400 on a display such as touch screen display 105. In some embodiments, camera control system 175 may provide a “master” settings menu, as described above in connection with FIG. 3. UI 400 may comprise a sub-menu accessible by selection of a sub-menu selection control from such a master settings menu. Camera control system 175 may be configured to return to the master settings menu in response to user selection of settings menu control 245 from UI 400. Camera control system 175 may be configured to save settings specified in UI 400, and to configure itself according to the received settings selections, in response to user selection of save settings control 351. Camera control system 175 may be configured to display camera UI 200 in response to user selection of camera UI control 352.

UI 400 comprises a settings menu including two menu categories. A first menu category provides controls 401 and 402 for selecting photograph number settings. The example controls 401 and 402 include a “take 1 photo” control 401 and a “take 2 photos” control 402. In some embodiments, controls for any number of additional photograph number settings, such as “take 3 photos”, “take 4 photos” etc. may be provided. In some embodiments, the controls 401-402 may be mutually exclusive, so that only one of controls 401-402 may be selected at a time. Selecting a control may automatically operate to de-select any previously selected control.

As described in connection with the multi-photo control 243, camera control system 175 may be configured to automatically take the number of photographs specified via the controls 401 or 402 in response to user activation of any of controls 231, 232, and/or 233. In some embodiments, the controls 401 and 402 may affect camera control system 175 operations in connection with a subset of controls 231, 232, and/or 233, such as by affecting operations of only shutter control 233. In some embodiments, the controls 401 and 402 may affect camera control system 175 operations in connection with all of controls 231, 232, and 233.

A second menu category in FIG. 4 provides controls 411, 412, 413, and 414 for selecting timer length settings. The example controls 411, 412, 413, and 414 include a selectable “05 secs” control 411, a selectable “10 secs” control 412, a selectable “15 secs” control 413, and a selectable “20 secs” control 414. In some embodiments, any number of additional timer length controls such as “2 secs”, “25 secs”, “12 secs” etc. may be provided. Camera control system 175 may be configured to apply a selected timer length setting in response to user activation of timer initiation control 232, and/or in connection with shutter control 233 when control 304 is selected, as described in connection with FIG. 3. In some embodiments, the controls 411-414 may be mutually exclusive, so that only one of controls 411-414 may be selected at a time. Selecting a control may automatically operate to de-select any previously selected control.

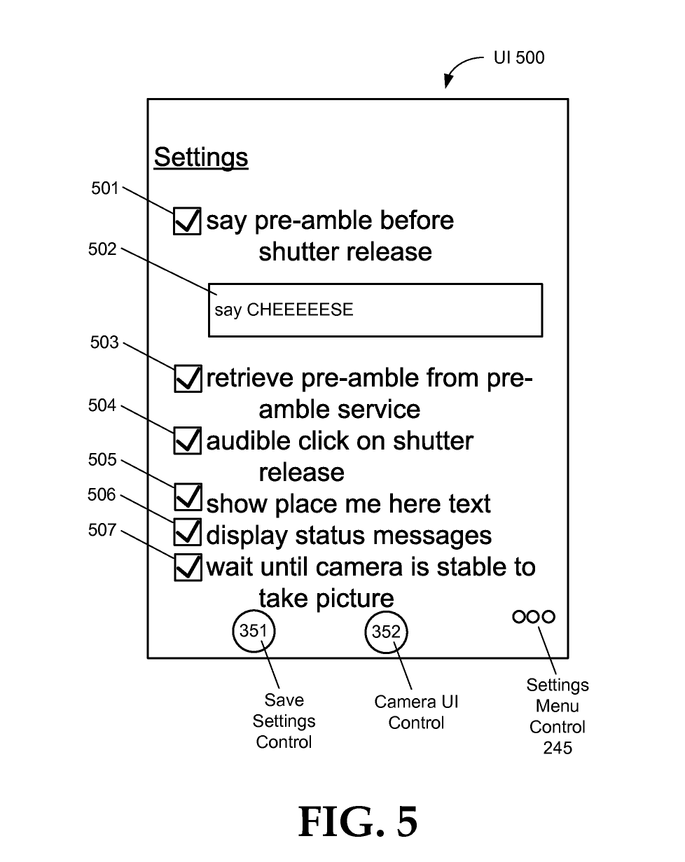

FIG. 5 illustrates a third example settings menu UI 500. Camera control system 175 may be configured to present UI 500 on a display such as touch screen display 105. In some embodiments, camera control system 175 may provide a “master” settings menu, as described above in connection with FIG. 3. UI 500 may comprise a sub-menu accessible by selection of a sub-menu selection control from such a master settings menu. Camera control system 175 may be configured to return to the master settings menu in response to user selection of settings menu control 245 from UI 500. Camera control system 175 may be configured to save settings specified in UI 500, and to configure itself according to the received settings selections, in response to user selection of save settings control 351. Camera control system 175 may be configured to display camera UI 200 in response to user selection of camera UI control 352.

UI 500 comprises a settings menu including a user-selectable “say pre-amble before shutter release” control 501, a field 502 adapted to receive a custom, user-specified preamble and/or display any pre-amble that is currently in use, a user-selectable “retrieve pre-amble from pre-amble service” control 503, a user-selectable “audible click on shutter release” control 504, a user-selectable “show place me here text” control 505, a user-selectable “display status messages” control 506, and a user-selectable “wait until camera is stable to take picture” control 507. In some embodiments, the controls 501 and 503-507 may be individually selectable and de-selectable, so that any combination of controls 501 and 503-507 may be simultaneously selected, and if desired, all of controls 501 and 503-507 may be simultaneously de-selected. Selecting a control 501 or 503-507 need not affect selections of other controls.

When the “say pre-amble before shutter release” control 501 is selected, the camera control system 175 may output an audible notification by the speaker 140 and/or 115 prior to activating the camera 125. The audible notification prior to activating the camera 125 may be referred to herein as a pre-amble. The pre-amble may comprise any sound, for example, the spoken words, “Say cheese”. The pre-amble may be output in connection with any or all of the camera activation controls 231, 232, and/or 233. For example, in some embodiments, the pre-amble may be output in connection with timer initiation control 232 and listening initiation control 231, while the pre-amble may optionally be omitted when the camera is activated from shutter control 233.

The audible notification (pre-amble) prior to activating the camera 125 may be user-customizable, so that the user may choose custom notifications. For example, the user may enter text in a field 502 adapted to receive a user-specified preamble, and camera control system 175 may cause device 100 to speak the text in field 502, according to the language settings for device 100, as a custom pre-amble. Some embodiments may allow users to browse to an audio file of their choosing for use as a pre-amble, or to record a custom pre-amble, instead of or in addition to allowing the user to provide text into field 502.

When the “retrieve pre-amble from pre-amble service” control 503 is selected, camera control system 175 may retrieve audible notifications (pre-ambles) from a network audible notifications service. For example, camera control system 175 may automatically retrieve surprising, humorous, or other audible notifications from a network service. New pre-ambles may be retrieved at any interval, e.g., hourly, daily, monthly, etc. Any current pre-amble to e used by camera control system 175 may be displayed in field 502. “Next” and “Back” buttons (not shown in FIG. 5) may allow users to scroll to a next or a previous pre-amble from the network service. The service may allow users to specify preferences, e.g., user language, geographical region, and other user profile/preference information so that pre-ambles suiting the user's tastes may be provided to device 100.

When the “audible click on shutter release” control 504 is selected, camera control system 175 may output an audible click when the camera is activated, e.g., to mimic the sound of mechanical camera action.

When the “show place me here text” control 505 is selected, camera control system 175 may display a composition instruction 705 in a camera UI 200, e.g., as shown in FIG. 7C. Camera control system 175 may also display, in camera UI 200, an indication 704 of a camera activation control location and a written instruction to activate the camera at the camera activation control location, as also illustrated in FIG. 7C. In some embodiments, the composition instruction 705 and the indication 704 may be separately controlled by implementing control 505 using two separate controls.

When the “display status messages” control 506 is selected, camera control system 175 may display status messages such as status message 702 in a camera UI 200, e.g., as shown in FIG. 7A. Status message 702 shows that the device 100 is currently “listening”, e.g., in response to user selection of the listening initiation control 231. Other status messages, such as “waiting for stable position”, “locating face(s)”, and/or status messages reflecting other operations which may be performed by camera control system 175 may also be displayed in some embodiments.

The “wait until camera is stable to take picture” control 507 may also be referred to herein as a stability activation control. When the stability activation control 507 is selected, the camera control system 175 may wait for stable conditions prior to activating camera 125 in response to user selection of a camera activation control 231, 232, or 235. In other words, if the device 100 is in motion when a camera activation control 231, 232, or 235 is selected and stability activation control 507 is selected, camera control system 175 may wait until the device 100 is no longer in motion (stable), and may then automatically activate camera 125. In some embodiments, camera control system 175 may be configured to detect camera motion with the motion sensor 164, e.g., by accessing a motion sensor API included in API 172. When the stability activation control 507 is selected, the camera control system 175 may delay camera activation when the camera 125 (or device 100 as a whole) is in motion; and may automatically activate the camera 125 when the camera 125 is stable. Any desired thresholds may be set to define camera motion and camera stability. For example, in some embodiments, some amount of motion may qualify as nonetheless “stable” for the purpose of proceeding to activate camera 125, and the allowed amount of camera motion may be set as appropriate for specific embodiments.

FIG. 6 illustrates a fourth example settings menu UI 600. Camera control system 175 may be configured to present UI 600 on a display such as touch screen display 105. In some embodiments, camera control system 175 may provide a “master” settings menu, as described above in connection with FIG. 3. UI 600 may comprise a sub-menu accessible by selection of a sub-menu selection control from such a master settings menu. Camera control system 175 may be configured to return to the master settings menu in response to user selection of settings menu control 245 from UI 600. Camera control system 175 may be configured to save settings specified in UI 600, and to configure itself according to the received settings selections, in response to user selection of save settings control 351. Camera control system 175 may be configured to display camera UI 200 in response to user selection of camera UI control 352.

UI 600 comprises a variety of example controls for selecting overlay settings, including a “none” control 601, a “rule of thirds grid” control 602, a “rule of thirds grid with portrait left” control 603, and a “rule of thirds grid with portrait right” control 604. In some embodiments, the controls 601-604 may be mutually exclusive, so that only one of controls 601-604 may be selected at a time. Selecting a control may automatically operate to de-select any previously selected control.

When the “none” control 601 is selected, camera control system 175 may display no overlays in camera UI 200, e.g., as shown in FIG. 2. When the “rule of thirds grid” control 602 is selected, camera control system 175 may display a rule of thirds grid 701 in camera UI 200, e.g., as shown in FIG. 7A. When the “rule of thirds grid with portrait left” control 603 is selected, camera control system 175 may display a rule of thirds grid 701 and a composition guide 703 in camera UI 200, e.g., as shown in FIG. 7B. When the “rule of thirds grid with portrait right” control 604 is selected, camera control system 175 may display a rule of thirds grid 701 and a composition guide 703 in camera UI 200, e.g., as shown in FIG. 7C.

The various overlays illustrated in FIGS. 7A, 7B, and 7C may assist with composing photographs and video. Any combination of overlays may be used in some embodiments. For example, in addition to the illustrated embodiments, some embodiments may provide composition guide 703 overlays without rule of thirds grid 701 overlays, and corresponding selectable controls may be included in FIG. 6. Rule of thirds grid 701 and composition guide 703 overlays, as well as instructions 704 and 705 may be particularly useful when asking persons unfamiliar with device 100 and/or camera control system UI 200 to take a picture. Pictures may be composed as desired with minimal instructions and confusion.

In some embodiments, camera control system 175 may be configured to activate and de-activate auto-focus features along with rule of thirds grid 701 and composition guide 703 overlays, i.e., in response to user selections of controls 602, 603, and 604. For example, in some embodiments the camera control system 175 may be configured to respond to user selection of control 602 by displaying a rule of thirds grid 701 in conjunction with providing user-guided autofocus, where the user-guided autofocus may be guided, e.g., using the touch display 105. The UI 200 as illustrated in FIG. 7A may comprise a rule of thirds grid with user-guided autofocus UI that is configured to receive a touch input at a position on the UI provided on the touch display, and to focus a camera image at the position in response to the touch input. For example, if the user touches the top left box in the rule of thirds grid 701 in FIG. 7A, the camera control system 175 may respond by focusing the image in the top left box of the display area 220. If the user touches the middle box in the rule of thirds grid 701 in FIG. 7A, the camera control system 175 may respond by focusing the image in the middle box, and so forth for the other boxes of the rule of thirds grid 701 in display area 220.

FIG. 6 and FIG. 7 illustrate controllable display of a composition guide 703 on the UI 200 on display 105, wherein the composition guide 703 is configured to trace a shape of a compositional element on the display 105. The composition guide 703 may trace any compositional element such as a building, a mountain, a person, a human torso, a group of people, an animal, or any other shape. When the camera control system 175 is configured to activate and de-activate auto-focus along with composition guide 703, camera control system 175 may automatically focus on the traced shape or a predetermined portion thereof. For example, the camera control system 175 may be configured to automatically focus on the head of the person traced in FIGS. 7B and 7C when the composition guide 703 overlay is present in the UI.

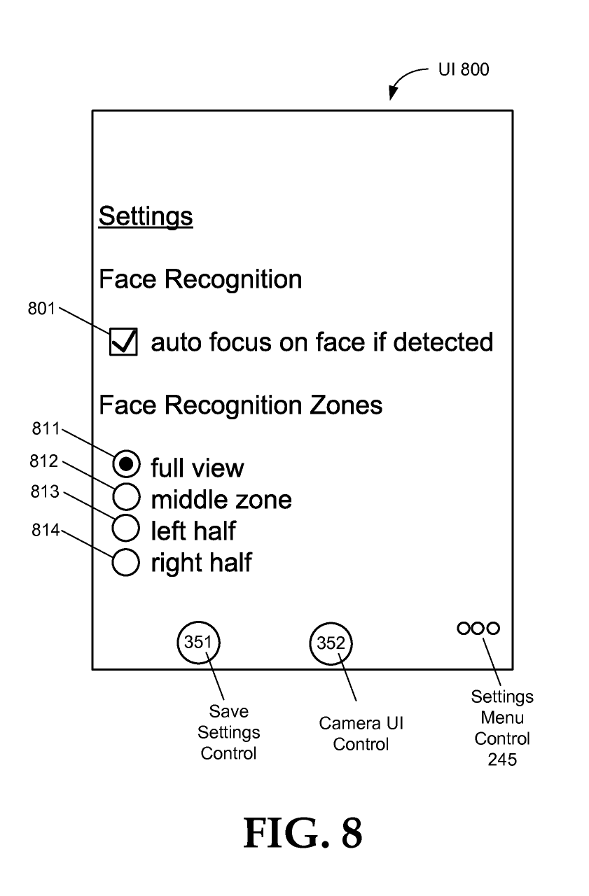

FIG. 8 illustrates a fifth example settings menu UI 800. Camera control system 175 may be configured to present UI 800 on a display such as touch screen display 105. In some embodiments, camera control system 175 may provide a “master” settings menu, as described above in connection with FIG. 3. UI 800 may comprise a sub-menu accessible by selection of a sub-menu selection control from such a master settings menu. Camera control system 175 may be configured to return to the master settings menu in response to user selection of settings menu control 245 from UI 800. Camera control system 175 may be configured to save settings specified in UI 800, and to configure itself according to the received settings selections, in response to user selection of save settings control 351. Camera control system 175 may be configured to display camera UI 200 in response to user selection of camera UI control 352.

UI 800 comprises an example face recognition activation/deactivation control, referred to as an “auto-focus on face if detected” control 801. UI 800 further comprises example controls for selecting face recognition zones, including a selectable “full view” control 811, a selectable “middle zone” control 812, a selectable “left half” control 813, and a selectable “right half” control 814. In some embodiments, the controls 811-814 may be mutually exclusive, so that only one of controls 811-814 may be selected at a time. Selecting a control may automatically operate to de-select any previously selected control.

When the “auto-focus on face if detected” control 801 is selected, camera control system 175 may employ face recognition system 174 to detect, prior to camera activation, an image of a face in a camera display area 220. For example, camera control system 175 may detect an image of a human face in display area 220. In some embodiments, camera control system 175 may use a face recognition system API in API 172 to activate face recognition system 174 to analyze image data from display area 220. Image data from display area 220 may comprise, e.g., image data from a portion of memory 163, or a dedicated graphics memory, which may be used for display area 220.

In some embodiments, detecting images of faces prior to camera activation may comprise analyzing all, or substantially all, image data from display area 220, including image data from display area 220 when a camera activation control 231, 232, or 233 has not been selected. In some embodiments, detecting images of faces prior to camera activation may comprise analyzing image data from display area 220 after a camera activation control 231, 232, or 233 is selected and before the camera 125 is activated to record a photograph or start a video.

Face recognition system 174 may use any face recognition criteria. In some embodiments, applied face recognition criteria may be sufficiently generalized to recognize substantially any human face, while not recognizing animal faces or other image elements that may comprise face-like features. In some embodiments, applied face recognition criteria may be generalized to recognize substantially any human face as well as non-human faces such as bird faces, dog faces, cat faces, etc., which faces may be recognized using face recognition criteria including the presence of a head structure with two eyes, a mouth, and/or other features therein. In some embodiments, applied face recognition criteria may specify an individual face, e.g., a face of the camera user, which may be recognized by face recognition criteria derived from a previous photograph of the individual which may be specified by a user for use by camera control system 175. In some embodiments, when a face is recognized, face recognition system 174 may provide face location coordinates of a face location within display area 220 to camera control system 175. Camera control system 175 may use face location coordinates to adjust camera 125 focus prior to camera activation as described herein.

When the “auto-focus on face if detected” control 801 is selected, camera control system 175 may automatically focus the camera 125 on detected images of faces in display area 220. Automatically focusing the camera 125 may be done prior to prior to camera activation as described above in connection with face recognition. When the “auto-focus on face if detected” control 801 is selected, however no face is detected in display area 220, camera control system 175 may default to a normal auto-focus setting, or other focus setting that would be applied by camera control system 175 had control 801 not been selected.

Some embodiments may comprise face detection zone selection controls such as 811, 812, 813, and 814. Face detection zone selection controls 811, 812, 813, and 814 may each be configured to receive a user selected zone in which to detect faces by the face recognition system 174. Camera control system 175 may be configured to detect face images in a user selected zone of the camera display area 220. For example, when the “full view” control 811 is selected, camera control system 175 may detect face images anywhere in display area 220. When multiple faces are detected, decision criteria may be applied to determine which face to focus on—e.g. the largest face may be focused, or an average focus setting may be applied to attempt to bring multiple faces in focus. When the “middle zone” control 812 is selected, camera control system 175 may detect face images in a middle zone of display area 220, e.g., in the middle square of the rule of thirds grid 701 in FIG. 7A. When a face is detected in the middle zone, camera control system 175 may focus on the middle zone face. Faces outside the middle zone need not be detected and/or need not be considered when focusing on the middle zone face. Similarly, when the “left half” control 813 or the “right half” control 814 is selected, camera control system 175 may detect face images in a left half or a right half of display area 220, and camera control system 175 may focus on faces detected in those zones, without considering faces that may be present in other, non-selected zones of display area 220.

This disclosure provides numerous features for a camera control system 175 and camera control system UI, recognizing that in some embodiments, some features may be omitted, the disclosed features may be combined in a variety of different ways, and the disclosed features may also be combined with further features not described herein. Some example camera control system UI may comprise multiple camera activation controls as shown in UI 200, the multiple camera activation controls comprising a listening initiation control 231, a timer initiation control 232, and a camera activation control. The listening initiation control 231 may be configured to initiate listening, by camera control system 175, to sound data received via a microphone 150 in response to a user activation of the listening initiation control 231, wherein the camera control system 175 may be configured to recognize a predetermined camera activation sound pattern in the received sound data and to activate a camera 125 to take a photograph or begin recording a video in response to the predetermined camera activation sound pattern. The timer initiation control 232 may be configured to initiate a countdown and to automatically activate the camera 125 after the countdown. The camera activation control 233 may be configured to allow, inter alia, immediately activating the camera 125.

In some embodiments, the camera activation control 233 may be configured to allow immediately activating the camera 125 in response to a user selection of, e.g., control 302, and the camera activation control 233 may be configurable by one or more different user selections 301, 303, and/or 304 to allow one or more of initiating listening or initiating a countdown to activating the camera 125.

Some example camera control system UI may comprise, in combination with or independent of the multiple camera activation controls, other UI features disclosed herein, such as a field 502 configured for user entry of a user-customizable audible notification, and wherein the camera control system 175 may be configured to output the audible notification by a speaker 140 prior to activating the camera 125.

Example UI may comprise a user activated rule of thirds grid 701 with user-guided autofocus on a touch display 105, wherein the rule of thirds grid 701 with user-guided autofocus may be configured to receive a touch input at a position on the touch display 105, and to focus the camera 125 at the position in response to the touch input. Example UI may comprise a user activated composition guide 703 on the display 105, wherein the composition guide 703 may be configured to trace a shape of a compositional element comprising a human torso on the display 105.

Example UI may comprise a user activated indication 704 of a camera activation control location, which may be accompanied by a written instruction to activate the camera 125 at the camera activation control location.

Example UI may comprise a user activated stability activation control 507 configured to adapt the camera control system 175 to detect camera 125 motion with a motion sensor 164, delay camera 125 activation when the camera 125 is in motion, and automatically activate the camera 125 when the camera is stable.

Example UI may comprise a user activated face recognition setting 801 that configures the camera control system 175 to detect, prior to camera 125 activation, an image of a face in a camera display area 220, and to automatically focus the camera 125 on a face when detected. In some embodiments, face detection zone controls 811-814 may be configured to receive a user selected zone in which to detect face images, and the camera control system 175 may be configured to detect the face images in a user selected zone of the camera display area 220. These and other features may be combined in a variety of ways in camera control system UI disclosed herein.

It will be understood by those of skill in the art that the functions and operations disclosed in the various diagrams and examples provided herein may be implemented by a range of method operations, hardware, software, firmware, and combinations thereof. Portions of the subject matter described herein may be implemented via Application Specific Integrated Circuits (ASICs), Field Programmable Gate Arrays (FPGAs), digital signal processors (DSPs), or other integrated formats. Portions of the subject matter described herein may also be implemented via integrated circuits and/or as one or more computer programs running on one or more computers. Designing the circuitry and/or writing the code for the software and or firmware is within the skill of one skilled in the art in light of this disclosure.

While certain example techniques have been described and shown herein using various methods, devices and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

1. A camera device, comprising:
a camera;
a microphone;
a processor;
a memory; and
a camera control system stored in the memory and executable by the processor, wherein camera control system comprises:
a listening initiation control, wherein the camera control system is configured to initiate listening to sound data received via the microphone in response to a user activation of the listening initiation control;
a sound recognition system configured to recognize a predetermined camera activation sound pattern in the received sound data, wherein the camera control system is configured to activate the camera to take a photograph or begin recording a video in response to the predetermined camera activation sound pattern.

2. The camera device of claim 1, wherein the predetermined camera activation sound pattern comprises three or more syllables.

3. The camera device of claim 1, wherein the predetermined camera activation sound pattern comprises the words “ready click”.

4. The camera device of claim 1, further comprising a speaker, and wherein the camera control system is configured to output an audible notification by the speaker when initiating listening in response to the user activation of the listening initiation control.

5. The camera device of claim 1, further comprising a speaker, and wherein the camera control system is configured to output an audible request by the speaker for a subsequent voice input in response to receiving a sound pattern other than the predetermined camera activation sound pattern.

6. The camera device of claim 1, wherein the camera control system is configured to activate the camera in response to receiving one or more sound patterns other than the predetermined camera activation sound pattern.

7. The camera device of claim 1, further comprising a speaker, and wherein the camera control system comprises a timer initiation control, and wherein the camera control system is configured to:
output an audible countdown by the speaker in response to a user initiation of the timer initiation control; and
automatically activate the camera after the audible countdown.

8. The camera device of claim 1, further comprising a speaker, and wherein the camera control system is configured to output an audible notification by the speaker prior to activating the camera.

9. The camera device of claim 8, wherein the audible notification prior to activating the camera is user-customizable.

10. The camera device of claim 9, wherein the camera control system is configured to retrieve audible notifications from a network audible notifications service.

11. The camera device of claim 1, wherein the camera device is provided in a mobile communications device equipped with a camera Application Programming Interface (API) adapted for application-based pre-capture camera control, and wherein the camera control system comprises an application executable by the mobile communications device and configured to access the camera API.

12. The camera device of claim 1, wherein the camera control system is configured to provide one or more of a voice-activated timer, a voice-activated flash, a voice-activated focus setting, a voice-activated ISO setting, or a voice-activated scene setting.

13. The camera device of claim 1, further comprising a touch display, and wherein the camera control system is configured to display multiple camera activation controls on the touch display, the multiple camera activation controls comprising the listening initiation control, a timer initiation control, and a camera activation control.

14. The camera device of claim 1, further comprising a touch display, and wherein the camera control system is configured to display a rule of thirds grid with user-guided autofocus on the touch display, wherein the rule of thirds grid with user-guided autofocus is configured to receive a touch input at a position on the touch display, and to focus a camera image at the position in response to the touch input.

15. The camera device of claim 1, wherein the camera control system comprises a multi-photo control configured to receive a user selected number of photographs, and wherein the camera control system is configured to take a number of photographs according to the user selected number of photographs.

16. The camera device of claim 15, wherein the multi-photo control is configured to toggle between one and two photographs.

17. The camera device of claim 1, further comprising a display, and wherein the camera control system is configured to controllably display a composition guide on the display, wherein the composition guide is configured to trace a shape of a compositional element on the display.

18. The camera device of claim 17, wherein the compositional element comprises a human torso.

19. The camera device of claim 17, wherein the camera control system is configured to automatically focus on the traced shape or a predetermined portion thereof.

20. The camera device of claim 1, further comprising a display, and wherein the camera control system is configured to controllably display an indication of a camera activation control location and a written instruction to activate the camera at the camera activation control location.

21. The camera device of claim 1, further comprising a motion sensor, and wherein the camera control system comprises stability activation control configured to:
detect camera motion with the motion sensor;
delay camera activation when the camera is in motion; and
automatically activate the camera when the camera is stable.

22. The camera device of claim 1, further comprising a face recognition system configured to detect, prior to camera activation, an image of a face in a camera display area, and automatically focus the camera on the image of the face when the image of the face is detected.

23. The camera device of claim 22, wherein the camera control system comprises a face detection zone control configured to receive a user selected zone to detect face images, and wherein the camera control system is configured to detect face images in the user selected zone.

24. A non-transitory computer readable storage medium having computer executable instructions executable by a processor, the instructions that, when executed by the processor, implement a camera control system, which causes the processor to:
provide a listening initiation control, wherein the camera control system is configured to initiate listening to sound data received via a microphone in response to a user activation of the listening initiation control; and
recognize a predetermined camera activation sound pattern in the received sound data, wherein the camera control system is configured to activate a camera to take a photograph or begin recording a video in response to the predetermined camera activation sound pattern.

25. A camera control system User Interface (UI), comprising:
multiple camera activation controls, the multiple camera activation controls comprising a listening initiation control, a timer initiation control, and a camera activation control;
wherein the listening initiation control is configured to initiate listening, by a camera control system, to sound data received via a microphone in response to a user activation of the listening initiation control, wherein the camera control system is configured to recognize a predetermined camera activation sound pattern in the received sound data and to activate a camera to take a photograph or begin recording a video in response to the predetermined camera activation sound pattern;
wherein the timer initiation control is configured to initiate a countdown and to automatically activate the camera after the countdown; and
wherein the camera activation control is configured to allow immediately activating the camera.

26. The camera control system UI of claim 25, wherein the camera control system UI comprises a field configured for user entry of a user-customizable audible notification, and wherein the camera control system is configured to output the audible notification by a speaker prior to activating the camera.

27. The camera control system UI of claim 25, wherein the UI comprises a user activated rule of thirds grid with user-guided autofocus on a touch display, wherein the rule of thirds grid with user-guided autofocus is configured to receive a touch input at a position on the touch display, and to focus the camera at the position in response to the touch input.

28. The camera control system UI of claim 25, wherein the UI comprises a user activated composition guide on the display, wherein the composition guide is configured to trace a shape of a compositional element comprising a human torso on the display.

29. The camera control system UI of claim 25, wherein the UI comprises a user activated indication of a camera activation control location and a written instruction to activate the camera at the camera activation control location.

30. The camera control system UI of claim 25, wherein the camera activation control is configured to allow immediately activating the camera in response to a user selection, and wherein the camera activation control is configurable by one or more different user selections to allow one or more of initiating listening or initiating a countdown to activating the camera.

31. The camera control system UI of claim 25, wherein the UI comprises a user activated stability activation control configured to:
adapt the camera control system to detect camera motion with a motion sensor;
delay camera activation when the camera is in motion; and
automatically activate the camera when the camera is stable.

32. The camera control system UI of claim 25, wherein the UI comprises a user activated face recognition setting that configures the camera control system to detect, prior to camera activation, an image of a face in a camera display area, and to automatically focus the camera on the image of the face when the image of the face is detected.

33. The camera control system UI of claim 32, wherein the camera control system comprises a face detection zone control configured to receive a user selected zone in which to detect face images, and wherein the camera control system is configured to detect face images in the user selected zone.
